(19) United States
(12) Patent Application Publication
(10) Pub. No.: US 2026/0227735 A1
(43) Pub. Date: Aug. 6, 2026

(54) SHEET ACCOMMODATING DEVICE, SHEET FEEDING DEVICE, AND IMAGE FORMING APPARATUS

(71) Applicant: CANON KABUSHIKI KAISHA, Tokyo (JP)

(72) Inventor: TOSHIYUKI ITO, Ibaraki (JP)

(21) Appl. No.: 19/424,472

(22) Filed: Dec. 18, 2025

(30) Foreign Application Priority Data
Jan. 31, 2025 (JP) 2025-014947

(51) Int. Cl. G03G 15/00; G03G 21/16

(52) U.S. Cl. CPC G03G 15/6511; G03G 21/1647; G03G 2221/1654

(57) ABSTRACT

A sheet accommodating device includes a rear-end regulating portion configured to regulate a position of a first end portion on an upstream side in a feeding direction of a sheet supported by a sheet support portion, and a regulating member that is provided to be detachably attachable and is configured to regulate a position of a second end portion on the upstream side in the feeding direction of the sheet supported by the sheet support portion, and a position of an upper surface of the second end portion. The regulating member is provided to be movable between a regulation position where the regulating member abuts on the second end portion and regulates a position of the end portion of the sheet and a spacing position spaced away from the second end portion.

### BACKGROUND

### Field of the Technology

The present disclosure relates to a sheet accommodating device that accommodates a sheet, a sheet feeding device, and an image forming apparatus.

### DESCRIPTION OF THE RELATED ART

Conventionally, there is known a configuration in which a feeding device that feeds a sheet stacked on a sheet stacking portion includes a rear-end regulating member that regulates a position of a rear end of the stacked sheet in a conveyance direction, and a rear-end regulating additional member that is longer than the rear-end regulating member in a width direction of the sheet. See, Japanese Patent Application Laid-Open No. 2022-88985. The rear-end regulating additional member includes a body including an upper surface abutting portion that abuts on an upper surface of the rear end of the sheet in the conveyance direction, and a rear-end regulating portion that regulates the position of the rear end of the sheet in the conveyance direction, and the rear-end regulating portion is attached to the body to be vertically movable.

However, in the related art, the upper surface abutting portion abuts on the upper surface of the rear end of the sheet stacked on the sheet stacking portion, in the conveyance direction. Therefore, when a sheet is replenished, it is not possible to place the sheet to be replenished on the sheet stacking portion from directly above, and it is necessary to stack the sheet while raising the sheet to avoid the upper surface abutting portion. Alternatively, it is necessary to temporarily remove the rear-end regulating additional member and then stack (replenish) the sheet, which deteriorates operability at the time of accommodating the sheet in an apparatus.

### SUMMARY

An aspect of the present disclosure provides a sheet support portion configured to support a sheet; a rear-end regulating portion configured to move in a feeding direction of the sheet and regulate a position of a first end portion on an upstream side in the feeding direction, supported by the sheet support portion; and a detachable regulating member configured to regulate a position of a second end portion on the upstream side, the second end portion being different from the first end portion in a width direction of the sheet perpendicular to the feeding direction and from a position of an upper surface of the second end portion. The regulating member is movable between a regulation position and a spacing position. In the regulation position, the regulating member abuts the second end portion and regulates a position of an end portion of the sheet. In the spacing position, the regulating member is spaced away from the second end portion.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic cross-sectional view of an image forming system;

FIG. 2 is a perspective view of a storage case;

FIG. 3 is a front view illustrating a feeding unit and a peripheral configuration thereof;

FIG. 4 is a top view illustrating the feeding unit and the peripheral configuration thereof;

FIG. 5 is a left side view illustrating a peripheral configuration of a separation air unit;

FIG. 6 is a perspective view illustrating a feeding unit and a peripheral configuration thereof;

FIG. 7 is a block diagram illustrating control blocks of the feeding unit;

FIG. 8 is a top view illustrating a tabbed sheet and a rear-end guide regulating member to be added;

FIG. 9 is a perspective view illustrating the rear-end guide regulating member;

FIG. 10 is a perspective view in which an additional regulating member is added to the rear-end guide regulating member;

FIG. 11 is a front view in which the rear-end guide regulating member is retracted to an upstream side; and

FIG. 12 is a perspective view in which the rear-end guide regulating member is retracted to one side guide side.

### DESCRIPTION OF THE EMBODIMENTS

Hereinafter, embodiments of the present disclosure will be described with reference to the drawings. The embodiments described below are exemplary of the present disclosure, and thus various technically possible limitations are given. However, the scope of the present disclosure is not limited by the following description. In addition, not all of the configurations described in the embodiment below are essential components of the present disclosure.

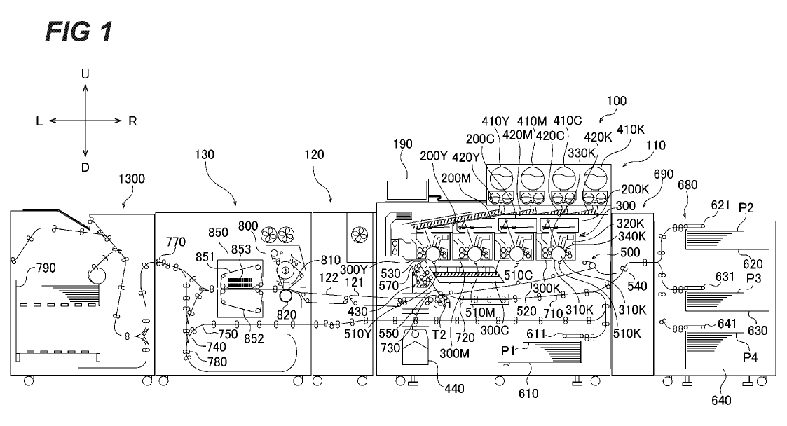

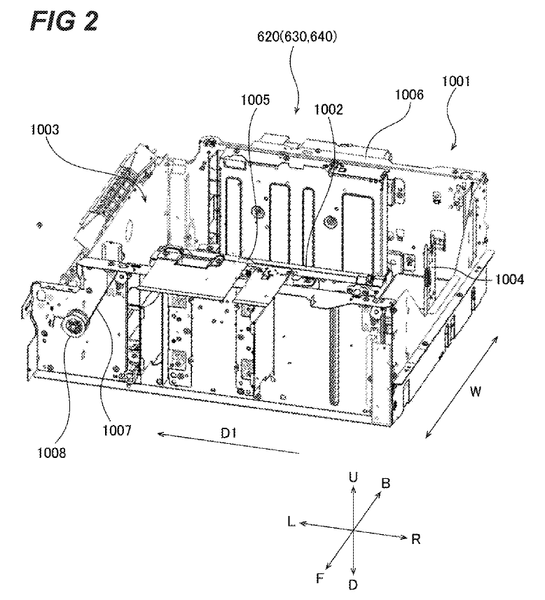

An upward direction U, a downward direction D, a rightward direction R, a leftward direction L, a backward direction B, and a forward direction F, as referenced herein, are illustrated at least in FIGS. 1 and 2. A side on which a user operation portion 190 is disposed with respect to an image forming system 100 illustrated in FIG. 1 is a front side, and the opposite side is a rear side (back side). In FIG. 1, a direction from the back of the surface of paper to the front is set as the forward direction F, and a direction from the front of the surface of paper to the back is set as the backward direction B. When an image forming portion 300K that forms a black image is set as a reference, a side on which an image forming portion 300Y that forms a yellow image is disposed is a left side. When the image forming portion 300Y that forms a yellow image is used as a reference, a side on which the image forming portion 300K that forms a black image is disposed is a right side. A direction that is perpendicular to the front-back and left-right directions and upward in the vertical direction is the upward direction U, and a direction that is perpendicular to the front-back and left-right directions and downward in the vertical direction is the downward direction D.

### Image Forming System

Hereinafter, the present embodiment will be described. FIG. 1 is a schematic cross-sectional view of the image forming system 100. The image forming system 100 includes a sheet deck 680, a relay path unit 690, an image forming apparatus 110, a second relay path unit 120, a fixing device 130, and a stacker 1300. As illustrated in FIG. 1, the sheet deck 680, the relay path unit 690, the image forming apparatus 110, the second relay path unit 120, the fixing device 130, and the stacker 1300 are coupled in this order from the right. Each unit will be described below with reference to FIG. 1.

The image forming system 100 includes at least the image forming apparatus 110 as an image forming module including an image forming portion 300 that forms an image on a sheet, and is an image forming apparatus including the sheet deck 680, the relay path unit 690, the second relay path unit 120, the fixing device 130, and the stacker 1300 as a plurality of coupled modules.

A sheet supplied from the sheet deck 680 is subjected to various types of processing when being conveyed along a conveyance path in each module, and is finally discharged to the stacker 1300.

The sheet deck 680, the relay path unit 690, the image forming apparatus 110, the second relay path unit 120, the fixing device 130, and the stacker 1300 may have respective individual housings, and the image forming system 100 may be configured by coupling the housings. Alternatively, the sheet deck 680, the relay path unit 690, the image forming apparatus 110, the second relay path unit 120, the fixing device 130, and the stacker 1300 may be disposed in one housing.

### Sheet Deck

The sheet deck 680 is an example of a sheet feeding device including a feeding unit that feeds a sheet. The sheet deck 680 includes storage cases 620, 630, and 640 that are sheet accommodation portions that accommodate sheet P. The storage cases 620, 630, and 640 are disposed in the housing (apparatus body) of the sheet deck 680 and are provided to be drawable toward the front side. A sheet P2 accommodated in the storage case 620 is picked up by the feeding unit 621 on a conveyance path of the sheet deck 680. The sheet picked up on the conveyance path of the sheet deck 680 is conveyed toward the relay path unit 690 at the subsequent stage by a conveying roller. The storage cases 620, 630, and 640 are disposed in this order from the vertical direction. The conveyance paths of a sheet conveyed from the respective storage cases join in the sheet deck, and the sheet is conveyed to the unit at the subsequent stage. The number of storage cases is not limited to three, and may be one, two, or four or more.

### Relay Path Unit

The relay path unit 690 includes a main conveyance path that conveys a sheet conveyed from the sheet deck 680 to the unit at the subsequent stage (the image forming apparatus 110 in the present embodiment).

### Image Forming Apparatus

The image forming apparatus 110 includes the image forming portion 300, a transfer device 500, and a sheet feeding cassette 610. The image forming portion 300 includes a photosensitive drum (photosensitive member) 310, a charging device 320, a developing device 330, an exposure device 200, and a drum cleaning device 340. The transfer device 500 includes a belt cleaning device 570 that collects toner on an intermediate transfer belt, as described herein. Here, the image forming portion 300 and the transfer device 500 are different units, without being limited thereto. For example, the image forming portion may be a configuration including the transfer device 500.

The image forming portions 300Y, 300M, 300C, and 300K will be further described. The image forming portions 300Y to 300K have substantially the same configuration except that colors of toners used in developing devices 330Y, 330M, 330C, and 330K are different, that is, yellow, magenta, cyan, and black. Therefore, hereinafter, the black image forming portion 300K will be described as a representative example, and description of other image forming portions is incorporated by reference, for conciseness.

The image forming portion 300K includes a photosensitive drum 310K, a charging device 320K, an exposure device 200K, and a developing device 330K. The surface of the photosensitive drum 310K as a photosensitive member is uniformly charged by the charging device 320K. Thereafter, an electrostatic latent image is formed by the exposure device 200K driven based on a signal of image information.

Here, the exposure device 200K is a laser scanner that scans the photosensitive drum 310K with a laser beam. The exposure device 200K may be an exposure head that is formed in an elongated shape extending in a rotational axis direction (main scanning direction) of the photosensitive drum 310K and exposes the photosensitive drum 310K by using a plurality of light emitting elements arranged along the rotational axis direction of the photosensitive drum 310K. The light emitting element that can be used for the exposure head is, for example, a light emitting diode or an organic electro-luminescence (organic EL).

Next, the transfer device 500 will be described. The transfer device 500 includes a primary transfer roller 510 that is a primary transfer unit, an intermediate transfer belt 520 that is an intermediate transfer member, a driving roller 530 and a stretching roller 540 that stretch the intermediate transfer belt, and a secondary transfer inner roller 550 that is a secondary transfer unit. The secondary transfer inner roller may also serve as a driving roller. The intermediate transfer belt 520 is stretched by a plurality of stretching rollers including the driving roller 530 and the secondary transfer inner roller 550, and is driven to move in the counterclockwise direction.

Next, the belt cleaning device 570 will be described. The belt cleaning device 570 includes a cleaner box 440 that accommodates residual toner collected from the drum cleaning device of each color and the belt cleaning device, and a toner conveyance path 430 that guides the residual toner from the belt cleaning device and the drum cleaning device to the cleaner box 440. The drum cleaning device of each color is the drum cleaning device 340 that collects residual toner remaining on the photosensitive drum without being transferred from the photosensitive drum of each color to the intermediate transfer belt 520. The belt cleaning device is the belt cleaning device 570 that collects residual toner remaining on the intermediate transfer belt without being transferred from the intermediate transfer belt 520 to the sheet.

The image forming apparatus 110 includes developer replenishment containers 410Y, 410M, 410C, and 410K. The developer replenishment containers 410Y, 410M, 410C, and 410K are containers that accommodate toners of yellow (Y), magenta (M), cyan (C), and black (K), respectively. The developer replenishment container 410K is connected to the developing device 330K via a developer conveyance path 420K. When toner in the developing device 330K is consumed by image formation, the toner is replenished from the developer replenishment container 410K to the developing device 330K via the developer conveyance path 420K. Although the relationship between the developer replenishment container 410K and the developing device 330K has been described, it is assumed that the developer replenishment container and the developing device are connected with the similar configuration for other colors.

The image forming apparatus 110 is configured to detect a toner remaining amount in the developer replenishment container. In a case where the toner runs out in the developer replenishment container, a user can replace the developer replenishment container.

The sheet feeding cassette 610 is disposed below the image forming portion 300 in the vertical direction. A sheet P1 fed from the sheet feeding cassette 610 by the feeding unit 621 is conveyed to a secondary transfer portion T2 via the conveyance path 710. The image forming apparatus 110 includes a reverse conveyance path. The reverse conveyance path is a path that conveys a sheet conveyed from the second relay path unit 120 at the subsequent stage to the secondary transfer portion T2 again. Here, a configuration in which the reverse conveyance path of the image forming apparatus 110 receives a sheet from the second relay path unit 120 has been exemplified, but the embodiment is not limited thereto. For example, a configuration in which the reverse conveyance path of the image forming apparatus 110 directly receives a sheet from the fixing device 130 may be made.

An image forming process executed by the image forming apparatus will be described. An image creation process of each color processed by each of the image forming portions 300Yto 300K is executed at a timing of sequentially superimposing toner images of the colors upstream in a moving direction, which have been primarily transferred onto the intermediate transfer belt 520. As a result, a full-color toner image is finally formed on the intermediate transfer belt 520 and conveyed to the secondary transfer portion T2. Transfer residual toner after passing through the secondary transfer portion T2 is removed from the intermediate transfer belt by the belt cleaning device 570.

An electrostatic latent image formed on the photosensitive drum 310K is developed by the developing device 330K using toner (developer), and a toner image (development) is formed on the surface of the photosensitive drum 310K and is made to be a visible image. Thereafter, a predetermined pressurizing force and a primary transfer voltage are applied to the developed toner image by the primary transfer roller 510K disposed to face the image forming portion 300K with the intermediate transfer belt 520 interposed. As a result, a toner image formed on the photosensitive drum 310K is primarily transferred onto the intermediate transfer belt 520. Transfer residual toner slightly remaining on the photosensitive drum 310K after the primary transfer is removed by the drum cleaning device 340K, and the next image creation process is prepared again.

A sheet P conveyed from the storage cases 620, 630, and 640 and the sheet feeding cassette 610 is conveyed to a registration roller 720 disposed in the middle of the conveyance path 710. The sheet P is sent to the secondary transfer portion T2 after skew feeding is corrected or a conveyance timing is corrected by the registration roller 720. The secondary transfer portion T2 is a transfer nip portion formed by the secondary transfer inner roller 550 and a secondary transfer outer roller 730 facing each other. In the secondary transfer portion T2, a secondary transfer voltage is applied to the secondary transfer inner roller 550, whereby the toner image is secondarily transferred from the intermediate transfer belt 520 to the sheet P.

With a conveying process and an image creation process described above, timings of the sheet P and the full-color toner image coincide with each other in the secondary transfer portion T2, and the toner image is secondarily transferred from the intermediate transfer belt 520 to the sheet P. Thereafter, the sheet P is conveyed to the fixing device.

### Second Relay Path Unit

The second relay path unit 120 delivers the sheet from the image forming apparatus 110 to the fixing device, as described herein. This is provided to fill a difference between a height of a discharge port through which the image forming apparatus 110 discharges a sheet and a height of a reception port through which a sheet of the fixing device, as described herein, is received. Here, the second relay path unit 120 supports a first conveyance belt 121 disposed to straddle the image forming apparatus 110 and supports a second conveyance belt 122 disposed to straddle the fixing device. A sheet carrying the unfixed toner is conveyed to the fixing device at the subsequent stage by the first conveyance belt 121 and the second conveyance belt 122.

The second relay path unit 120 includes a conveying roller that conveys a sheet from the fixing device 130 to the image forming apparatus 110. The conveying roller is included in a part of a reverse conveyance path, and conveys the sheet conveyed from the fixing device 130 to the image forming apparatus 110 when duplex printing is performed. The conveying roller is disposed below the first conveyance belt and the second conveyance belt in the vertical direction. The second relay path unit 120 includes a conveyance path that conveys a sheet from the fixing device 130, as described herein, to the image forming apparatus 110. When duplex printing is performed, the sheet passes through the conveyance path.

### Fixing Device

The fixing device 130 includes a fixing unit 800, a cooling unit 850, and a reverse conveyance path. The above-described sheet conveyed by the second conveyance belt 122 is conveyed to the fixing unit 800. The fixing unit 800 forms a nip portion for nipping the sheet by the heating unit 810 and the pressure roller 820. Toner carried on the sheet conveyed to the fixing unit 800 is pressurized and heated at a nip portion that nips the sheet of the fixing unit 800, and is melted on the sheet.

The sheet that has passed through the fixing unit 800 is conveyed to the cooling unit 850. The cooling unit includes an upper belt 851, a lower belt 852, a heat sink 853, and a cooling fan. In FIG. 1, the upper belt is rotationally driven in a clockwise direction, and the lower belt is rotationally driven in a counterclockwise direction. The sheet that has passed through the nip portion of the fixing unit 800 is conveyed between the upper belt 851 and the lower belt 852, nipped between both the belts, and conveyed. Both belts absorb heat from the sheet and toner. The heat sink 853 comes into contact with the inner peripheral surface of the stretched upper belt 851, absorbs heat from the upper belt 851, and dissipates the heat. The heat sink 853 may be disposed for the lower belt 852. The heat sink 853 is cooled by the cooling fan. A cooling mechanism using a refrigerant may be provided instead of the heat sink 853 and the cooling fan.

The cooling unit 850 is provided to absorb heat from the toner on the sheet to promote fixing of the toner to the sheet. By providing the cooling unit 850, it is possible to suppress sheet discharge adhesion in which sheets stacked on a sheet discharge tray, described herein, are adhered to each other by unfixed toner.

In the case of single-sided printing, the sheet P on which the toner image has been fixed is conveyed to a unit at the subsequent stage by the discharge roller 770 that rotates forward. On the other hand, in the case of double-sided printing, the sheet P is conveyed to the reverse conveyance path 750 by a flapper 749 and a reversing roller 780, is reversed from front to back, and is conveyed to the image forming apparatus 110. The subsequent conveyance and the image creation process of the second surface are similar to those in the above-described case, and thus the description thereof is incorporated by reference, for conciseness.

### Stacker

The stacker 1300 is a stacker capable of stacking a large number of sheets. The stacker 1300 includes a stack tray 790 including a lift table and an ejection table as a tray on which a sheet is stacked. The stacker 1300 also has a sheet sorting finishing function. The sheet that has passed through an inspection unit is stacked on the lift table of the stack tray by a conveying roller of the stacker 1300. In the stacker 1300, a sheet is conveyed to a reversing portion such that the input orientation of the sheet and the orientation of the sheet discharged to the stack tray become the same, and the sheet is switched back and then stacked on the stack tray.

### Sheet Deck

Next, the configuration of the sheet deck 680 will be described in detail. FIG. 2 is a perspective view of the storage case 620. The sheet deck 680 as a sheet feeding device includes storage cases 620, 630, and 640 as sheet accommodation devices attached to be drawable, and feeding units 621, 631, and 641 that feed sheets accommodated in the storage cases.

Sheets accommodated in the above-described three storage cases 620, 630, and 640 included in the sheet deck 680 are fed by the feeding units 621, 631, and 641 corresponding to the respective storage cases. Since the storage cases 620, 630, and 640 have similar configurations and the feeding units 621, 631, and 641 have similar configurations, the storage case 620, the feeding unit 621, and peripheral configurations thereof will be described in detail below. The storage cases 620, 630, and 640 need not have the same configuration, and the feeding units 621, 631, and 641 have the same configuration. For example, the maximum number of stacked sheets that can be accommodated in the storage cases 620, 630, and 640 and the size of the sheets may be different from each other.

### Storage Case

As illustrated in FIG. 2, the storage case 620 that is a sheet accommodation portion includes a body portion 1001, a lifter plate 1002 supported by the body portion 1001, a leading end guide 1003, a rear end guide 1004, a first side guide 1005, and a second side guide 1006. The lifter plate 1002 (sheet support portion) supports a sheet and is suspended by a lifter wire 1007. The lifter wire 1007 is wound up or unwound by a wire pulley 1008 driven by a motor, whereby the lifter plate 1002 is configured to be movable in an up-down direction while maintaining the horizontal state of a sheet.

The leading end guide 1003 regulates the position of a leading end of a sheet stacked on the lifter plate 1002, that is, an end portion on a downstream side in a sheet feeding direction D1. The rear end guide 1004 (rear-end regulating portion) regulates the position of a rear end of the sheet stacked on the lifter plate 1002, that is, a first end portion of the sheet on an upstream side in the sheet feeding direction D1. The first side guide 1005 and the second side guide 1006 as side-end regulating portions are configured to be movable in a width direction W perpendicular to the sheet feeding direction D1, and regulate the positions of the end portions on both sides in the width direction W of the sheet stacked on the lifter plate 1002. The storage case 620 is configured to be detachably attachable to the body portion 1001 in the width direction W, is drawn out to the first side guide 1005 side in the width direction W, and is attached to the second side guide 1006 side. In other words, the storage case 620 is configured to be detachably attachable to the body portion 1001 in the front-rear direction, is drawn out to the forward direction F side, and is attached to the backward direction B side.

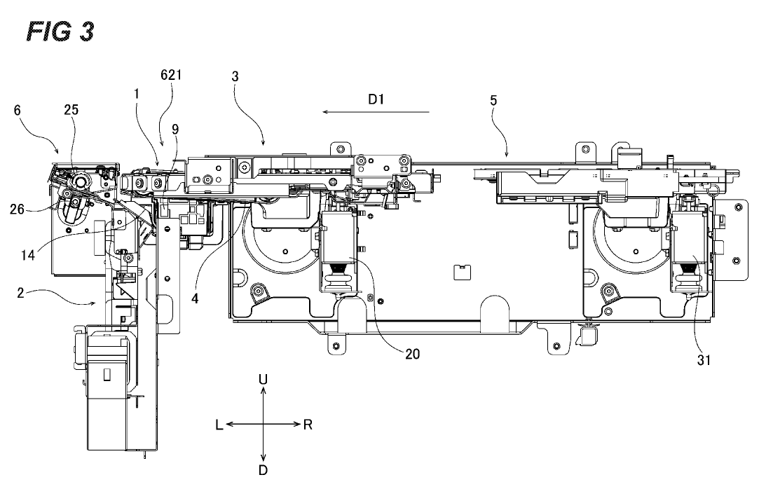

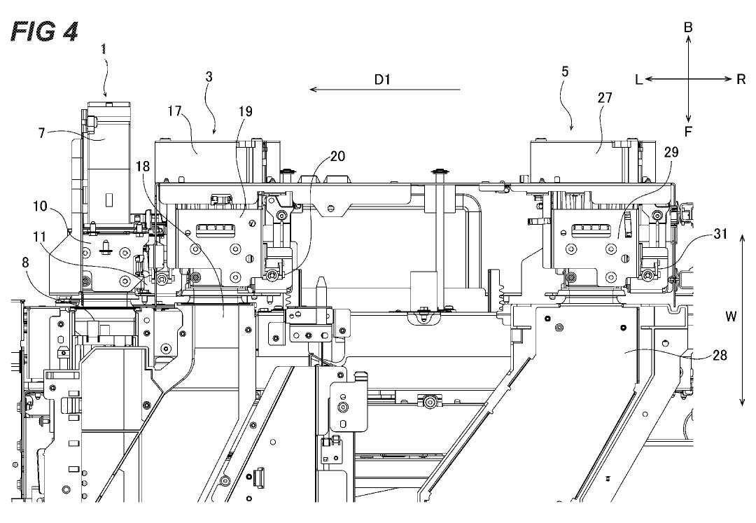

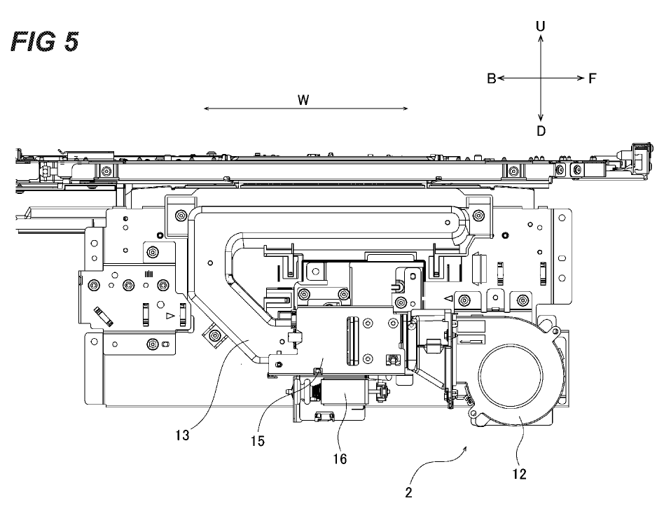

FIG. 3 is a front view illustrating the feeding unit 621 and a peripheral configuration thereof. FIG. 4 is a top view illustrating the feeding unit 621 and the peripheral configuration thereof. FIG. 5 is a left side view illustrating a peripheral configuration of a separation air unit. The feeding unit 621 causes a sheet to float by loosening air from an end surface in a width direction of a sheet bundle, sucks the sheet to a separation belt 4 by suction air having the negative pressure, then causes the rear end of the sheet to float by second suction air having the negative pressure, and separates the sheet into one sheet by the separation air blown from the leading end of the sheet bundle. The feeding unit 621 feeds the sheets one by one by rotating the separation belt 4.

As illustrated in FIGS. 3 to 5, the feeding unit 621 includes a loosening air unit 1, a separation air unit 2, a first suction unit 3, the separation belt 4, a second suction unit 5, and a drawing roller unit 6.

As illustrated in FIG. 3, the loosening air unit 1 as a first blowing portion includes a side fan 7 capable of controlling a rotation speed, a side duct 8, a side nozzle 9, and a side fan valve 10. The cylindrical side duct 8 is connected to the side fan 7 via the side fan valve 10, and the side nozzle 9 is provided at a distal end of the side duct 8. The side nozzle 9 is provided on the rear side of the storage case 620 and at a downstream end portion in the sheet feeding direction D1. The side fan valve 10 is provided between the side fan 7 and the side duct 8, and is configured to be openable and closable by a side fan valve solenoid 11. A blowing timing of the loosening air can be controlled by controlling opening and closing of the side fan valve 10.

Air (hereinafter, referred to as loosening air) sent from the side fan 7 passes through the side fan valve 10 and the side duct 8, and is discharged from the side nozzle 9. The side duct 8 is configured to be movable in the width direction W in conjunction with the second side guide 1006.

As illustrated in FIG. 5, the separation air unit 2 includes a front fan 12, a front duct 13, a front nozzle 14, and a front fan valve 15. The cylindrical front duct 13 is connected to the front fan 12 via the front fan valve 15, and the front nozzle 14 is provided at a distal end of the front duct 13. The front nozzle 14 is provided at a downstream end portion of the storage case 620 in the sheet feeding direction D1. The front fan valve 15 is provided between the front fan 12 and the front duct 13, and is configured to be openable and closable by a front fan valve solenoid 16. A blowing timing of the separation air can be controlled by controlling opening and closing of the front fan valve 15.

Air (hereinafter, referred to as separation air) sent from the front fan 12 passes through the front fan valve 15 and the front duct 13, and is discharged from the front nozzle 14. The front nozzle 14 through which the separation air is discharged is disposed toward the separation belt 4 above the sheet stacked on the storage case 620.

The loosening air unit 1 and the separation air unit 2 described above constitute a blowing unit that blows air from the downstream side toward the upstream side in the sheet feeding direction D1 with respect to the downstream end portion in the sheet feeding direction D1 of the sheet supported by the lifter plate 1002.

As illustrated in FIGS. 3, 4, and 6, the first suction unit 3 includes a first suction fan 17, a first suction chamber 18, and a first suction fan valve 19. The first suction chamber 18 is connected to the first suction fan 17 via the first suction fan valve 19, and has a space therein. The first suction fan valve 19 is provided between the first suction fan 17 and the first suction chamber 18, and is configured to be openable and closable by a first suction fan valve solenoid 20. When the first suction fan valve 19 is opened in a state where the first suction fan 17 is driven, the inside of the first suction chamber 18 has negative pressure. The first suction chamber 18 has an opening at a position facing the upper surface of the sheet stacked on the storage case 620, and the opening communicates with an internal space of the first suction chamber 18.

The separation belt 4 is disposed around the first suction chamber 18, and the separation belt 4 as a feeding belt is wound around a belt driving roller and a belt driven roller. When the belt driving roller is driven by a belt driving motor 24, the separation belt 4 rotates, and the belt driven roller is driven to rotate by the separation belt 4.

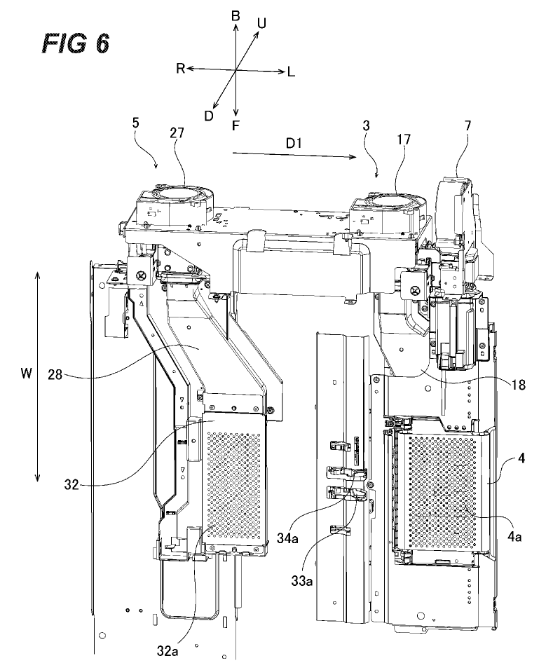

FIG. 6 is a perspective view illustrating the feeding unit 621 and the peripheral configuration thereof. The separation belt 4 is provided with a plurality of circular holes 4a, and the plurality of circular holes 4a located on the lower surface side of the separation belt 4 communicates with the opening of the first suction chamber 18. Therefore, when the internal space of the first suction chamber 18 has negative pressure, air around the separation belt 4 can be sucked into the first suction chamber 18 via the opening and the plurality of holes 4a of the separation belt 4 (hereinafter, referred to as first suction air). In a case where there is a sheet near the lower surface of the separation belt 4, the sheet is attracted to the separation belt 4. When the separation belt 4 is driven in a state where the sheet is attracted, the sheet can be conveyed.

As illustrated in FIG. 3, the drawing roller unit 6 is disposed downstream in the sheet feeding direction D1 of the separation belt 4, and includes a driving roller 25 and a driven roller 26. The driving roller 25 is driven by a drawing roller driving motor 37, and the driven roller 26 is driven to rotate following the driving roller 25. The sheet fed while being sucked by the separation belt 4 is conveyed by the drawing roller unit 6.

As illustrated in FIGS. 3, 4, and 6, the second suction unit 5 as an upstream suction portion is disposed upstream of the separation belt 4 in the sheet feeding direction D1. The second suction unit 5 includes a second suction fan 27, a second suction chamber 28, and a second suction fan valve 29. The second suction chamber 28 is connected to the second suction fan 27 via the second suction fan valve 29, and has a space therein. The second suction chamber 28 has an opening at a position facing the upper surface of the sheet stacked on the storage case 620, and the opening communicates with an internal space of the second suction chamber 28. The second suction fan 27 can generate negative pressure in the internal space of the second suction chamber 28.

The second suction fan valve 29 is configured to be openable and closable by a second suction fan valve solenoid 31. When the second suction fan valve 29 is opened in a state where the second suction fan 27 is driven, the inside of the second suction chamber 28 has negative pressure.

A chamber guide 32 is attached to the second suction chamber 28 to cover an opening, and the chamber guide 32 as a guide member is provided with a plurality of holes 32a. The plurality of holes 32a of the chamber guide 32 communicates with the second suction chamber 28. Therefore, when the internal space of the second suction chamber 28 has negative pressure, the air around the chamber guide 32 can be sucked into the second suction chamber 28 through the plurality of holes 32a of the chamber guide 32 (hereinafter, referred to as second suction air). In a case where there is a sheet near the lower surface of the chamber guide 32, the sheet is blown up toward the chamber guide 32.

In addition, a sheet detection sensor 33 and a sheet detection flag 33a, and a sheet presence/absence detection sensor 34, and a sheet presence/absence detection flag 34a are disposed between the separation belt 4 and the chamber guide 32 in the sheet feeding direction D1.

The sheet detection flag 33a hangs down toward the uppermost sheet of sheets stacked on the lifter plate 1002, and comes into contact with the surface of the uppermost sheet at the time of sheet feeding.

The sheet detection sensor 33 detects the height of the uppermost sheet supported by the lifter plate 1002 based on the position of the sheet detection flag 33a. The sheet detection flag 33a comes into contact with the uppermost sheet on the lifter plate 1002, thereby rotating from a non-detection position to a detection position. In a state where the sheet detection flag 33a is located at the detection position, the sheet detection sensor 33 is in a detection state (ON).

The sheet presence/absence detection flag 34a hangs down toward the uppermost sheet of sheets stacked on the lifter plate 1002, and comes into contact with the surface of the uppermost sheet at the time of sheet feeding.

The sheet presence/absence detection sensor 34 detects the presence or absence of the sheet supported by the lifter plate 1002 based on the position of the sheet presence/absence detection flag 34a. The sheet presence/absence detection flag 34a comes into contact with the uppermost sheet on the lifter plate 1002, thereby rotating from a non-detection position to a detection position. In a state where the sheet presence/absence detection flag 34a is located at the detection position, the sheet presence/absence detection sensor 34 is in the detection state (ON). In addition, in a case where a sheet is not on the lifter plate 1002 and the lifter plate 1002 is at a predetermined height, the sheet presence/absence detection flag 34a falls into an opening formed in the lifter plate 1002, thereby rotating from the detection position to the non-detection position. Therefore, the sheet presence/absence detection sensor 34 is in a non-detection state (OFF).

### Control Block

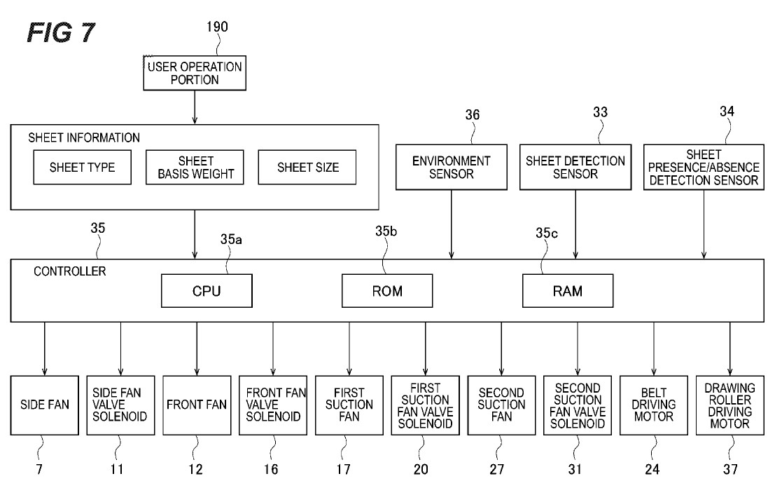

FIG. 7 is a block diagram illustrating control blocks of the feeding unit 621 of the image forming system 100. The image forming system 100 includes a user operation portion 190 capable of inputting sheet information, that is information regarding a sheet to be fed, and a controller 35.

The user operation portion 190 includes physical buttons, a liquid crystal panel, and the like. The sheet information includes a sheet size, a sheet basis weight that is a weight per unit area of a sheet, and a sheet type that is a type of a sheet such as plain paper, coated paper, synthetic paper, and a PET sheet. The controller 35 includes a CPU 35a, a ROM 35b, and a RAM 35c. Various programs are stored in the ROM 35b, and the CPU 35a reads and executes these programs. The RAM 35c is used as a work area of the CPU 35a.

An environment sensor 36, the sheet detection sensor 33, and the sheet presence/absence detection sensor 34 are connected to the controller 35. The environment sensor 36 can detect humidity in the storage case 620. The environment sensor 36 may detect not only the ambient humidity but also the ambient temperature and the like.

By the sheet information and the ambient humidity, it is possible to estimate the time required for separating sheets to be fed, the ease of separation, and the like. Therefore, the controller 35 sets the optimum feeding condition of a sheet based on the sheet information and the ambient humidity. The feeding condition includes a feeding interval of the sheet, a feeding speed, and rotational speeds of the side fan 7, the front fan 12, the first suction fan 17, and the second suction fan 27.

For example, a sheet having a large basis weight or size has a heavy weight per sheet, and thus it is preferable to increase the rotation speed of each fan. On the other hand, a sheet having a small basis weight or size has a light weight per sheet. Therefore, when the rotation speed of each fan is increased, the sheet flutters, which causes conveyance failure or skew feeding. Therefore, it is preferable to set the rotation speed of each fan to a low speed in a sheet having a small basis weight or size as compared with a sheet having a large basis weight or size. In addition, in a type of sheet in which sheets are likely to be in close contact with each other, particularly in a high humidity environment, by increasing the rotation speed of each fan or widening the feeding interval, the sheets can be stably separated and fed.

The controller 35 controls the side fan 7, the side fan valve solenoid 11, the front fan 12, the front fan valve solenoid 16, the first suction fan 17, the first suction fan valve solenoid 20, the second suction fan 27, the second suction fan valve solenoid 31, the belt driving motor 24, and the drawing roller driving motor 37 based on the set feeding condition.

### Operation of Tabbed Sheet

Hereinafter, an operation of a tabbed sheet will be described.

In recent years, there has been an increasing demand for creating a booklet and the like in an image forming apparatus, and a sheet with a tab at an end portion of the sheet (hereinafter, referred to as a tabbed sheet S) may be used as a partition sheet. Accordingly, it is necessary to feed the tabbed sheet S from the sheet deck 680 as the sheet feeding device. Therefore, it is necessary to enable the tabbed sheet S to be fed even in such a sheet feeding device of an air feeding system.

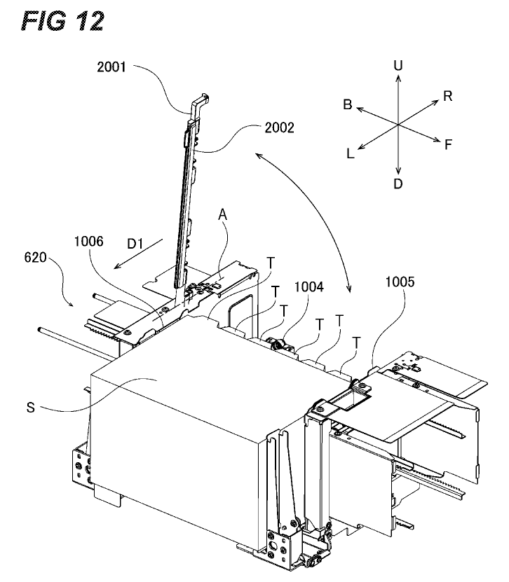

Here, the tabbed sheet S is provided with a tab T (FIG. 12) at the rear end in the conveyance direction of the sheet, which is a sheet end portion. For example, in a case where a tabbed sheet bundle including a plurality of tabbed sheets S is stacked and accommodated in the storage case 620, the tabbed sheet bundle includes a plurality of tabbed sheets with tabs in which the position of the tab T at the sheet end portion is different in the width direction W of the sheet.

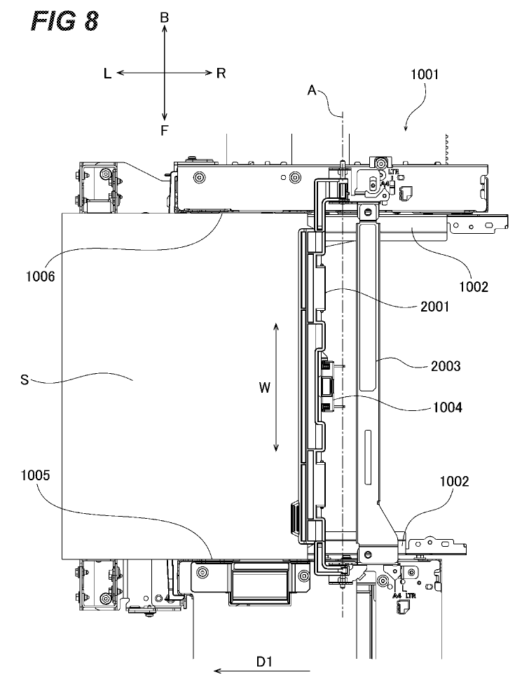

FIG. 8 is a diagram illustrating a state in which the tabbed sheet S having a predetermined size is set in the sheet feeding device of the air feeding system. In this case, the tabbed sheet S is supported by the lifter plate 1002 in a state where the tab T at the sheet end portion is located on the upstream side in the sheet feeding direction, the first side guide 1005 and the second side guide 1006 abut on both side ends of the tabbed sheet S in the width direction, and the rear end guide 1004 abuts on the tab T of the tabbed sheet S.

When a feeding operation is started in such a state, air is blown from the front nozzle 14 to the leading end side of the tabbed sheet S. At this time, since the rear end guide 1004 is provided only in the central portion in the width direction, a part of the tabbed sheet S in which the tab T is not in contact with the rear end guide 1004 moves backward (upstream side in the feeding direction).

As described above, when the tabbed sheet S that does not regulate the tab T by the rear end guide 1004 moves backward, wind pressure is weakened by a distance from the front nozzle 14. Therefore, it is not possible to regulate the tab T by the rear end guide 1004. For example, the leading end portion of the uppermost tabbed sheet S and the second tabbed sheet S from the top does not sufficiently float and sag. As a result, the air blown from the front nozzle 14 hardly enters between the sheets, and the leading end of the sheet is not appropriately loosened.

Alternatively, since the floating of the sheet is not stable, the other sheet is also affected to be in an unstable floating state and repeatedly move up and down. In such a floating state, problems such as jamming due to double feeding or attraction failure to the separation belt 4 and an occurrence of corner folding of the sheet occur.

In addition, feeding of the tabbed sheet S is desired not only in the sheet feeding device of the air feeding system but also in a sheet feeding device of a system of feeding a sheet by a roller and having a configuration in which a tray on which a sheet is stacked is lifted and lowered by a lifter mechanism.

However, in the sheet feeding device that feeds a sheet by such a roller, similarly to the sheet feeding device of the air feeding system described above, it is not possible to regulate the tab T by the rear end guide 1004, and the tabbed sheet S may move backward. In this case, when the roller that feeds the sheet is disposed on the leading end side of the sheet, there is a concern that it is not possible to feed the tabbed sheet S and feeding failure of the sheet occurs. Even in a case where the sheet can be fed, a timing of feeding the sheet is greatly deviated, and thus, there is a concern that the sheet interval is widened and the productivity is lowered or delay jam is detected.

### Rear-End Guide Regulating Member

Therefore, the storage case 620 as the sheet accommodation portion according to the present embodiment includes a rear-end guide regulating member 2001 (regulating member) that regulates the position of the upper surface of the end portion on the upstream side in the feeding direction, i.e., the position of the rear end upper surface of the sheet accommodated in the storage case 620.

Here, the configuration in which the rear-end guide regulating member 2001 is a tab guide that abuts on the upper surface of the tab T of the tabbed sheet S provided with the tab T at the end portion in a feeding direction of the sheet to regulate the position is exemplified, but the present embodiment is not limited thereto.

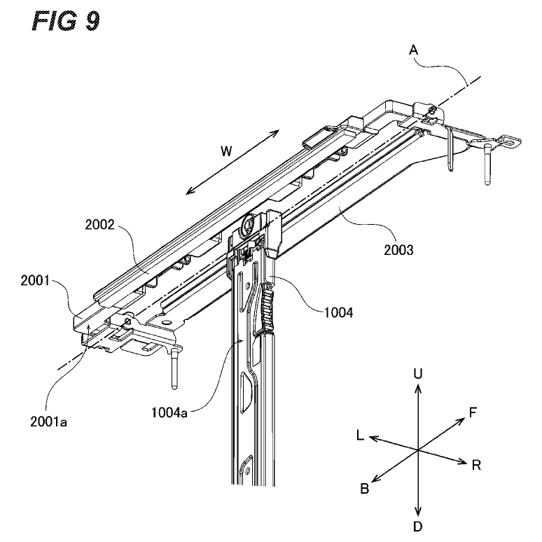

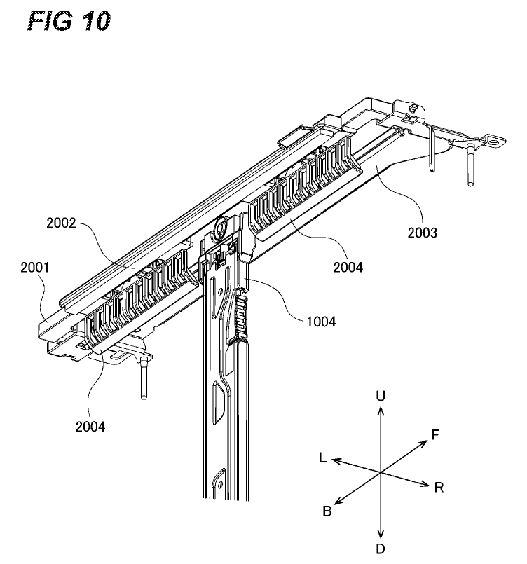

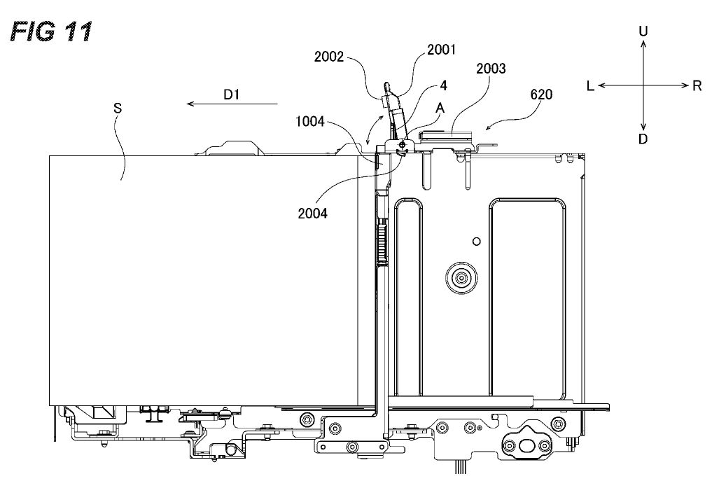

The rear-end guide regulating member will be described with reference to FIGS. 8 to 12. FIG. 8 is a top view illustrating the tabbed sheet S and the rear-end guide regulating member 2001 to be added, and is a view illustrating a state in which the rear-end guide regulating member 2001 is provided on the upper surface of the lifter plate 1002. FIG. 9 is a perspective view illustrating the rear-end guide regulating member. FIG. 10 is a perspective view in which an additional regulating member 2004 is added to the rear-end guide regulating member 2001. FIG. 11 is a front view in which the rear-end guide regulating member 2001 is retracted to the upstream side. FIG. 12 is a perspective view in which the rear-end guide regulating member 2001 is retracted to one side guide 1006 side.

As illustrated in FIGS. 8 and 9, the rear-end guide regulating member 2001 has a width wider than the rear end guide 1004 in the width direction W. Here, the rear-end guide regulating member 2001 has a length capable of pressing all of a plurality of tabs T having different positions in the width direction W of the sheet.

The rear-end guide regulating member 2001 regulates the position of the rear end of the sheet stacked on the lifter plate 1002, that is, a second end portion on the upstream side in the sheet feeding direction D1, and the position of the upper surface of the rear end of the sheet. The second end portion of the sheet regulated by the rear-end guide regulating member 2001 is different from the first end portion of the sheet regulated by the rear end guide 1004 in position in the width direction W perpendicular to the sheet feeding direction D1. The rear-end guide regulating member 2001 is provided to be movable between a regulation position where the rear-end guide regulating member 2001 abuts on the upper surface of the rear end of the sheet and regulates the position of the end portion of the sheet, and a spacing position where the rear-end guide regulating member 2001 is spaced away from the upper surface of the rear end of the sheet and is retracted away from, i.e. to a region outside, the end portion of the sheet. The rear-end guide regulating member 2001 illustrated in FIGS. 8 and 9 is supported to be rotatable about an axis A in the width direction W of the sheet, and specifically, is rotatably supported by a support base 2003 supported by the body portion 1001 of the storage case. Both ends of the support base 2003 in the width direction are supported by the side guides 1005 and 1006 of the storage case. In other words, the support base 2003 has attachment portions attached to the side guides 1005 and 1006 of the storage case at both ends in the width direction. The support base 2003 is not limited to the body portion 1001 of the storage case, and may be configured to be supported by another portion of the storage case such as the body portion.

The rear-end guide regulating member 2001 illustrated in FIGS. 8 and 9 is rotated about the axis A in the width direction W between the regulation position (FIG. 8) where the rear-end guide regulating member 2001 abuts on the upper surface of the rear end of the sheet and performs regulation, and the spacing position (FIG. 11) where the rear-end guide regulating member 2001 is spaced away from the upper surface of the rear end of the sheet and retracted to a region outside the end portion of the sheet. That is, when a sheet is replenished, the rear-end guide regulating member 2001 is rotated to the upstream side in the feeding direction of the sheet and is moved to the spacing position, as illustrated in FIG. 11. With this configuration, the user can replenish the sheet from above only by rotating the rear-end guide regulating member 2001 without removing the support base 2003 at the time of sheet replenishment. That is, it is possible to improve the operability at the time of accommodating the sheet in the apparatus.

As illustrated in FIG. 9, the rear-end guide regulating member 2001 includes a pressing member 2002 that presses and regulates the upper surface of the rear end of the sheet. The pressing member 2002 is made of an elastic member such as sponge, and directly presses the sheet, so that the sheet is less likely to be displaced. Therefore, it is possible to regulate the rear end position of the sheet and to reliably feed the tabbed sheet S.

Further, the rear-end guide regulating member 2001 may be configured to include an additional regulating member 2004 that abuts on the end portion on the upstream side in the sheet feeding direction D1, which is the rear end of the sheet, and regulates the position. The additional regulating member 2004 is rotatably supported by the rear-end guide regulating member 2001, and is configured to be rotatable between the regulation position (FIG. 10) where the additional regulating member 2004 abuts on the rear end of the sheet and performs regulation, and the spacing position (FIG. 11) where the additional regulating member 2004 is spaced away from the rear end of the sheet and retracted to a region outside the end portion of the sheet. With this configuration, it is possible to further regulate the deviation in the feeding direction of the sheet, and it is possible to improve the operability at the time of accommodating the sheet in the apparatus.

Here, the configuration in which the rear-end guide regulating member 2001 is rotatable about the axis A in the width direction W has been exemplified, but the present embodiment is not limited thereto. For example, as illustrated in FIG. 12, the rear-end guide regulating member 2001 may have a configuration in which one end portion (here, an end portion on the back side) in the width direction W of the sheet is supported to be rotatable with respect to one side guide 1006 about the axis A in the sheet feeding direction D1. In this case, the other end portion of the rear-end guide regulating member 2001 in the width direction W of the sheet is detachably attachable to the other side guide 1005, and is rotated to one side (here, the back side) in the width direction W of the sheet and moved to the spacing position. Also in this configuration, it is possible to improve the operability at the time of accommodating the sheet in the apparatus.

The configuration in which the user manually moves the rear-end guide regulating member 2001 between the regulation position and the spacing position at the time of sheet replenishment has been exemplified, but the present embodiment is not limited thereto. For example, the rear-end guide regulating member 2001 may be set to automatically move to the regulation position or the spacing position.

In this case, for example, the rear-end guide regulating member 2001 illustrated in FIG. 12 is configured to be biased in a direction from the regulation position to the spacing position by a biasing member, e.g. a spring. The rear-end guide regulating member 2001 is disengaged from the sheet deck 680 in conjunction with the operation of drawing the storage case 620 from the sheet deck 680, and is moved to the spacing position by a biasing force of the biasing member. On the other hand, the rear-end guide regulating member 2001 is engaged with the sheet deck 680 in conjunction with the operation of attaching the storage case 620 to the sheet deck 680, and is moved to the regulation position against the biasing force of the biasing member. With such a configuration, since the rear-end guide regulating member 2001 is moved in position in conjunction with the attaching and detaching operation of the storage case, the operability is further improved.

Alternatively, the rear-end guide regulating member 2001 may be configured to be brought back to the regulation position by the own weight or a biasing force of a spring or the like when the user supports the rear-end guide regulating member 2001 at the spacing position with his/her hand at the time of sheet replenishment and releases his/her hand when the replenishment is ended. In this case, it is preferable to provide a damper or the like that attenuates the moving speed when the rear-end guide regulating member 2001 moves from the spacing position to the regulation position.

In the above-described embodiment, as the sheet accommodating device, the storage case which is attached to the sheet deck as the sheet feeding device constituting the image forming system as the image forming apparatus in which a plurality of modules is coupled, to be drawable, has been described as an example, but the present embodiment is not limited thereto. For example, the sheet accommodating device may be attached to be drawable with respect to an image forming apparatus including a feeding unit and an image forming portion. Also in this case, it is possible to obtain similar effects by applying the present disclosure to the sheet accommodating device.

In the above-described embodiment, the electrophotographic system has been exemplified as a recording system, but the recording system is not limited thereto, and for example, another recording system such as an inkjet system may be used.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-014947, filed January 31, 2025, which is hereby incorporated by reference herein in its entirety.

What is claimed is:

1. A sheet accommodating device comprising:
a sheet support portion configured to support a sheet;
a rear-end regulating portion configured to move in a feeding direction of the sheet and regulate a position of a first end portion on an upstream side in the feeding direction, supported by the sheet support portion; and
a detachable regulating member configured to regulate a position of a second end portion on the upstream side, the second end portion being different from the first end portion in a width direction of the sheet perpendicular to the feeding direction and from a position of an upper surface of the second end portion,
wherein:
the regulating member is movable between a regulation position and a spacing position,
in the regulation position, the regulating member abuts the second end portion and regulates a position of an end portion of the sheet, and
in the spacing position, the regulating member is spaced away from the second end portion.

2. The sheet accommodating device according to claim 1, wherein:
the regulating member is wider than the rear-end regulating portion in the width direction,
the regulating member is configured to move between the regulation position where the regulating member abuts the upper surface of the second end portion and regulate a position of the end portion of the sheet, and
in the spacing position, the regulating member is separated from the upper surface of the second end portion and is retracted away from the end portion of the sheet.

3. The sheet accommodating device according to claim 1, further comprising:
a side-end regulating portion configured to regulate a position of a side end of the sheet in the width direction, wherein
the regulating member is detachably attachable to the side-end regulating portion.

4. The sheet accommodating device according to claim 1, wherein
the regulating member is supported to be rotatable about an axis of the sheet in the width direction, and is configured to rotate to the upstream side in the feeding direction to move to the spacing position.

5. The sheet accommodating device according to claim 1, wherein
one end portion of the regulating member in the width direction of the sheet is supported to be rotatable about an axis of the sheet in the feeding direction, and the regulating member is configured to rotate to one side of the sheet in the width direction and move to the spacing position.

6. The sheet accommodating device according to claim 5, further comprising:
an apparatus body including a feeding unit configured to feed a sheet and to be drawable from the sheet accommodating device, wherein: the regulating member is biased from the regulation position toward the spacing position by a biasing member, and
in conjunction with drawing of the sheet accommodating device from the apparatus body, the regulating member disengages from the apparatus body and moves to the regulation position by a biasing force of the biasing member.

7. The sheet accommodating device according to claim 6, wherein
in conjunction with attaching the sheet accommodating device to the apparatus body, the regulating member is engaged with the apparatus body moves to the spacing position against the biasing force of the biasing member.

8. The sheet accommodating device according to claim 1, wherein
the regulating member includes a pressing member configured to press the upper surface of the second end portion on the upstream side in the feeding direction.

9. The sheet accommodating device according to claim 8, wherein
the pressing member is an elastic member.

10. The sheet accommodating device according to claim 1, further comprising:
an additional regulating member that has a width wider than the rear-end regulating portion in the width direction, configured to abut the second end portion on the upstream side in the feeding direction and regulate a position of the end portion of the sheet.

11. The sheet accommodating device according to claim 1, wherein
the regulating member is configured to abut an upper surface of a tab of a tabbed sheet provided at an end portion of the sheet in the feeding direction and to regulate a position of the end portion of the sheet.

12. A sheet feeding device comprising:
a sheet accommodating device; and
a feeding unit configured to feed a sheet accommodated in the sheet accommodating device and to be drawable from the sheet accommodating device,
wherein:
the sheet accommodating device includes:
a sheet support portion configured to support a sheet;
a rear-end regulating portion configured to move in a feeding direction of the sheet and regulate a position of a first end portion on an upstream side in the feeding direction, supported by the sheet support portion; and
a detachable regulating member configured to regulate a position of a second end portion on the upstream side, the second end portion being different from the first end portion in a width direction of the sheet perpendicular to the feeding direction, and from a position of an upper surface of the second end portion,
the regulating member is movable between a regulation position and a spacing position,
in the regulating member, the regulating member abuts the second end portion and regulates a position of an end portion of the sheet, and
in the spacing position, the regulating member is spaced away from the second end portion.

13. The sheet feeding device according to claim 12, wherein
the feeding unit includes a belt, the feeding being configured to suck a sheet by air pressure, and feed the sheet by rotating the belt.

14. The sheet feeding device according to claim 13, wherein
the feeding unit includes a blower unit configured to blow the air from a downstream side toward an upstream side in the feeding direction with the sheet supported by the sheet support portion.

15. An image forming apparatus comprising:
at least one image forming module including an image forming portion configured to form an image on a sheet, wherein:
the at least one image forming module is configured to couple with a plurality of image forming modules
the at least one image forming module is configured as a sheet feeding device that includes a sheet accommodating device attached to be drawable and a feeding unit is configured to feed a sheet accommodated in the sheet accommodating device,
the sheet accommodating device is coupled to the at least one image forming module,
the sheet accommodating device includes:
a sheet support portion configured to support a sheet;
a rear-end regulating portion configured to move in a feeding direction of the sheet and regulate a position of a first end portion on an upstream side in the feeding direction supported by the sheet support portion; and
a detachable regulating member configured to regulate a position of a second end portion on the upstream side and a position of an upper surface of the second end portion, the second end portion being different from the first end portion in a width direction of the sheet perpendicular to the feeding direction,
the regulating member is movable between a regulation position and a spacing position,
in the regulation position, the regulating member abuts the second end portion and regulates a position of an end portion of the sheet and
in the spacing position, the regulating member is spaced away from the second end portion.

16. An image forming apparatus comprising:
a sheet accommodating device attached to be drawable;
a feeding unit configured to feed a sheet accommodated in the sheet accommodating device; and
an image forming portion configured to form an image on a sheet,
wherein:
the sheet accommodating device includes:
a sheet support portion configured to support a sheet;
a rear-end regulating portion configured to move in a feeding direction of the sheet and regulate a position of a first end portion on an upstream side in the feeding direction supported by the sheet support portion; and
a detachable regulating member configured to regulate a position of a second end portion on the upstream side in the feeding direction supported by the sheet support portion and a position of an upper surface of the second end portion, the second end portion being different from the first end portion in a width direction of the sheet perpendicular to the feeding direction, and
the regulating member is movable between a regulation position and a spacing position,
in the regulation position, the regulating member abuts the second end portion and regulates a position of an end portion of the sheet and
in the spacing position, the regulating member is spaced away from the second end portion.
